(19) United States
(12) Patent Application Publication
(10) Pub. No.: US 2007/0090059 A1
(43) Pub. Date: Apr. 26, 2007

(54) Remote water quality monitoring systems and techniques

(76) Inventors: Robert J. Plummer, Indianapolis, IN (US); H. Martin Harmless II, Indianapolis, IN (US); Brian T. O'Dell, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/187,644

(22) Filed: Jul. 22, 2005

(51) Int. Cl. C02F 1/00

(52) U.S. Cl. 210/743

(57) ABSTRACT

One embodiment involves a method for monitoring water associated with at least one of a water purification, distribution, or treatment facility. The method includes operating a number of monitoring units remotely positioned with respect to one another to at least partially perform the monitoring, the units each including several different types of sensors to detect correspondingly different characteristics of the water, a processing subsystem, and a two-way communication subsystem. For each of the units, the method includes processing signals corresponding to the different characteristics with the processing subsystem. Additionally, for one of the units, the method includes detecting an abnormal condition by executing diagnostic logic and communicating the abnormal condition to a host with the two-way communication subsystem for the one of the units.

### BACKGROUND OF THE INVENTION

The use of biological, chemical, and radiological weapons against our country represents a very real threat in these uncertain times. Experts on terrorism have warned of this potential, as have others in prominent governmental positions. In fact, terrorists both abroad and at home have been caught planning attacks on American water supplies. The tactic of “poisoning the enemy's wells” is an ages-old means of waging war, and was used to deny drinking water to the populace and their livestock.

The primary goal of terrorists is to create fear and to disrupt daily life. Terrorism disrupts society and causes confusion, fear, and “knee jerk” reactions, as opposed to measured response. The fact remains that the United States is vulnerable to terrorist attack, and water supplies represent targets that could generate significant impact on, not only the local populace, but also upon the nation as a whole. Many cities often depend on water to be supplied from external sources, including reservoirs, rivers, lakes, and well fields. An accidental or intentional release of toxic chemicals, biological agents, and radioactive substances into water supplies and/or distribution systems presents a significant threat to densely populated areas of the country and military installations.

Additionally, not all threats come from terrorists. Employee incompetence or malfunctioning equipment can create the opportunity for an unintentional, but deadly, water contamination event. For example, in 2004, several people died in Walkerton, Ontario due to contracting bacterial infections from drinking city water. Unbeknownst to the water company operators, the chlorination system had been malfunctioning for some time, leaving the citizens unprotected.

A crucial component of successful protection against threats is the ability to detect them early. For once a threat is introduced into a water supply, instant detection enables early mitigation, which provides a chance to reduce or avoid the chances of serious damage, sickness or death. Unfortunately, the ability to detect pathogens in water in a real time, continuous manner that enables prompt remedial action is limited. Accordingly, there are needs for further advancements in this area of technology.

### SUMMARY OF THE INVENTION

One embodiment of the present invention includes a method comprising monitoring water associated with at least one of a water source, water purification facility, water distribution facility, or water treatment facility, and operating a number of monitoring units remotely positioned with respect to one another to at least partially perform the monitoring. The units each include several different types of sensors to detect correspondingly different characteristics of the water, a processing subsystem and a two-way communication subsystem. Each of the units process signals corresponding to the different characteristics with their processing subsystems. When one of the units detects an abnormal condition by executing diagnostic logic, it communicates the abnormal condition to a host with its two-way communication subsystem.

Another embodiment of the present invention includes a method comprising monitoring water associated with at least one of a water source, water purification facility, water distribution facility, or water treatment facility, and operating a number of monitoring units remotely positioned with respect to one another to at least partially perform the monitoring. The units each include several sensors, a processing subsystem, and a communication subsystem. At least one of the units senses pH, oxidation reduction potential, chlorine content, and radiation content of the water with the sensors and provides corresponding sensor signals. The method further comprises determining an abnormal condition of the water as a function of the sensor signals with the processing subsystem and communicating the abnormal condition to another device with the communication subsystem.

A further embodiment of the present invention includes a system for monitoring a water network comprising a number of monitoring units and a host computer. The monitoring units are positioned at different locations in the network and each include sensors to detect chlorine content, a pH level, oxidation reduction potential, and radiation content of water in the water network, a processing subsystem and a two-way communication subsystem. The host computer has a processor and memory. The system includes each unit being operable to process signals from the sensors with the processing subsystem, detect an abnormal condition by executing diagnostic logic, and communicate the abnormal condition to the host computer with the two-way communication subsystem.

Yet another embodiment of the present invention includes a device for detecting radiation in a supply of water comprising a first radiation detector inside a conduit for contact with the water and a second radiation detector outside the conduit for establishing a baseline radiation level for reference. The device further comprises a processor for processing signals from the first and second radiation detectors to determine the level of radiation in the water and comparing it to the background level.

Even yet another embodiment of the present invention is a method comprising monitoring water associated with at least one of a water source, water purification facility, water distribution facility, or water treatment facility. The method further comprises operating a number of monitoring units remotely positioned with respect to one another to at least partially perform the monitoring, the units each including one or more sensing devices to detect correspondingly different characteristics of the water and a local data processor. The method further comprises the local data processor receiving data representing the characteristics from the sensing devices, analyzing the data, and communicating the data via a two-way communication system to a central computing system.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of a remote water quality monitoring system according to one disclosed embodiment.

FIG. 2 is a front view of a component of the remote water quality monitoring system according to the embodiment shown in FIG. 1.

FIG. 3 is a front, partial cross-sectional view of a segment of a component of the remote water quality monitoring system according to the embodiment shown in FIG. 1.

FIG. 4 is a flow chart describing a process relating to the remote water quality monitoring system according to the embodiment shown in FIG. 1.

FIG. 5 is another flow chart describing a process relating to the remote water quality monitoring system according to the embodiment shown in FIG. 1.

FIG. 6 is a view of a computer illustrated map of an area associated with the remote water quality monitoring system according to the embodiment shown in FIG. 1.

FIG. 7 is a view of a computer screen illustrating monitoring information associated with the remote water quality monitoring system according to the embodiment shown in FIG. 1.

### DESCRIPTION OF SELECTED EMBODIMENTS

For the purposes of promoting an understanding of the principles of the inventions, reference will now be made to the embodiments illustrated in the drawings and specific language will be used to describe the same. It will nevertheless be understood that no limitation of the scope of the inventions is thereby intended. Any alterations and further modifications of the principles of the inventions as illustrated or described herein are contemplated as would normally occur to one skilled in the art to which the inventions relate.

Certain embodiments relate to a remote sensor system design that is capable of performing nearly any sensing and data analysis task. A local data processor device can fuse data streams from a variety of sensors, able to sense characteristics of the environment in which the sensors are placed, and then locally determine the current state of that environment. Sensors can respond to a variety of stimuli, including physical parameters, chemical parameters or biological parameters. The resultant data and analysis can be communicated to a host computer and other remote computers and/or the local data processor can initiate remote and local actions based on the resultant data and analysis. In one embodiment, a system includes real time online detection and measurement of certain physical and chemical parameters that, in combination, can provide important information. One embodiment involves selecting a group of water quality parameters and monitoring for significant changes in their values. By comparing relational changes, it is believed that the presence of threats currently not detectable directly can be inferred from the relational changes. Surprisingly it has been found that selection of chlorine content, pH and oxidation reduction potential (and optionally radiation) as the parameters to monitor provides a baseline ability to detect water quality issues in a reliable and cost effective manner. Additional, more advanced sensors, such as UV absorbance spectrometers or gas chromatographs, can also be added to improve the ability to detect many expected contaminant situations.

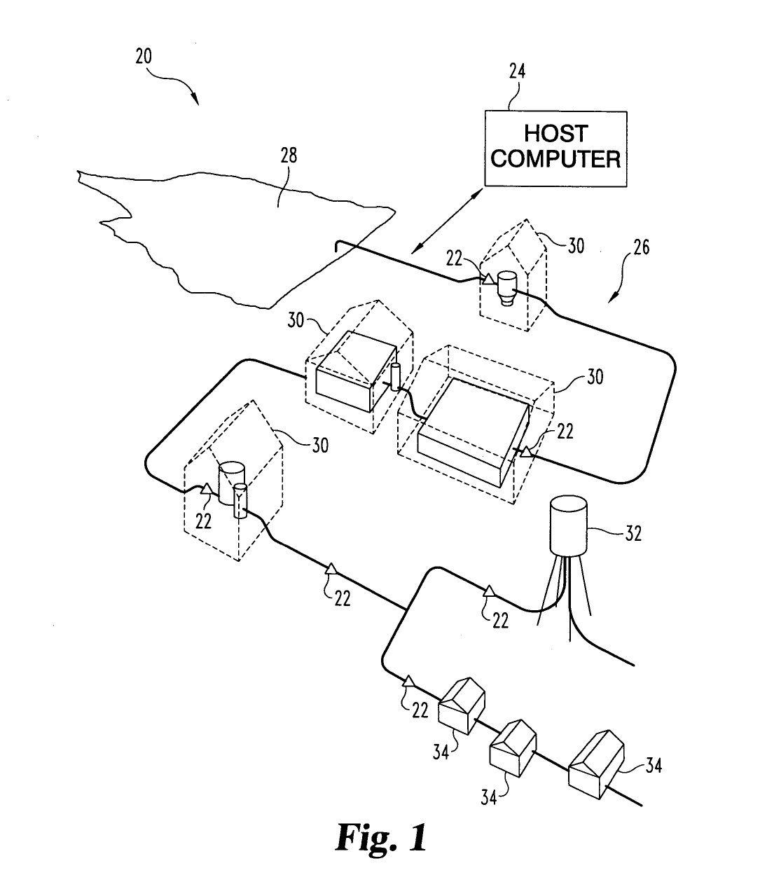

Referring now to FIG. 1, there is shown a diagram of a remote water quality monitoring system 20. System 20 includes one or more monitoring units 22. Monitoring units 22 communicate either via a wired connection or wirelessly to a host computer 24. In one embodiment, system 20 is used in conjunction with a water treatment and distribution facility 26. Generally, facility 26 can take water from a lake 28 and process the water through various treatment buildings 30. After treatment by facility 26, the treated water can be distributed to a water tower 32 or delivered to houses 34, as examples. As illustrated in FIG. 1, monitoring units 22 can be located inside one or more buildings 30 and/or positioned at other locations throughout water treatment and distribution facility 26.

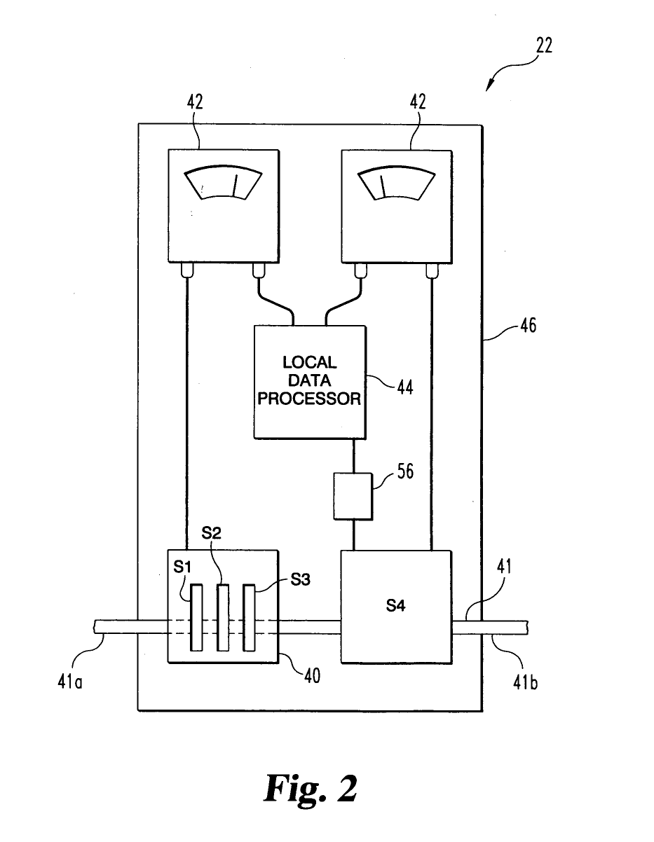

FIG. 2 illustrates a monitoring unit 22. The unit 22 includes sensors S1-S4. In one embodiment, S1 measures pH, S2 measures chlorine content, S3 measures oxidation reduction potential (ORP), and S4 measures radiation. In the illustrated embodiment, sensors S1-S3, measuring pH, chlorine content, and ORP, are integrated as a hybrid system onto a single collective sensing device 40. It has been found that these three parameters (pH, chlorine content and ORP) provide information sufficient to cost effectively detect water quality issues, but it should be appreciated that sensors S1-S4 could be designed to measure other parameters and/or other sensors could be incorporated into the monitoring unit 22. Pipe 41 receives and transmits water through sensors S1-S4. Sensors S1-S4 receive water via inlet section 41a. Water is thereafter transmitted through sensors S1-S4 and exits through outlet section 41b to a waste area. In one embodiment, inlet section 41a is connected to and receives water from a water conduit incorporated in water treatment and distribution facility 26. The data collected via sensors S1-S4 is transferred to monitoring gauges 42. Thereafter, the data is transmitted either via a wired connection or wirelessly to local data processor 44. Local data processor 44 is a programmable application-specific device that provides an interface between sensors S1-S4 and a central control and information logging system, such as host computer 24. Local data processor 44 processes the sensor data retrieved from sensors S1-S4 in accordance with software within processor 44. Processor 44 intelligently assimilates, integrates, and processors the data gathered by sensors S1-S4, to yield a useful actionable output. In one embodiment, monitoring unit 22 includes positioning of the various components described above on a panel 46. In one embodiment, monitoring unit 22, including panel 46, is wall mounted inside a building 30 within water treatment and distribution facility 26.

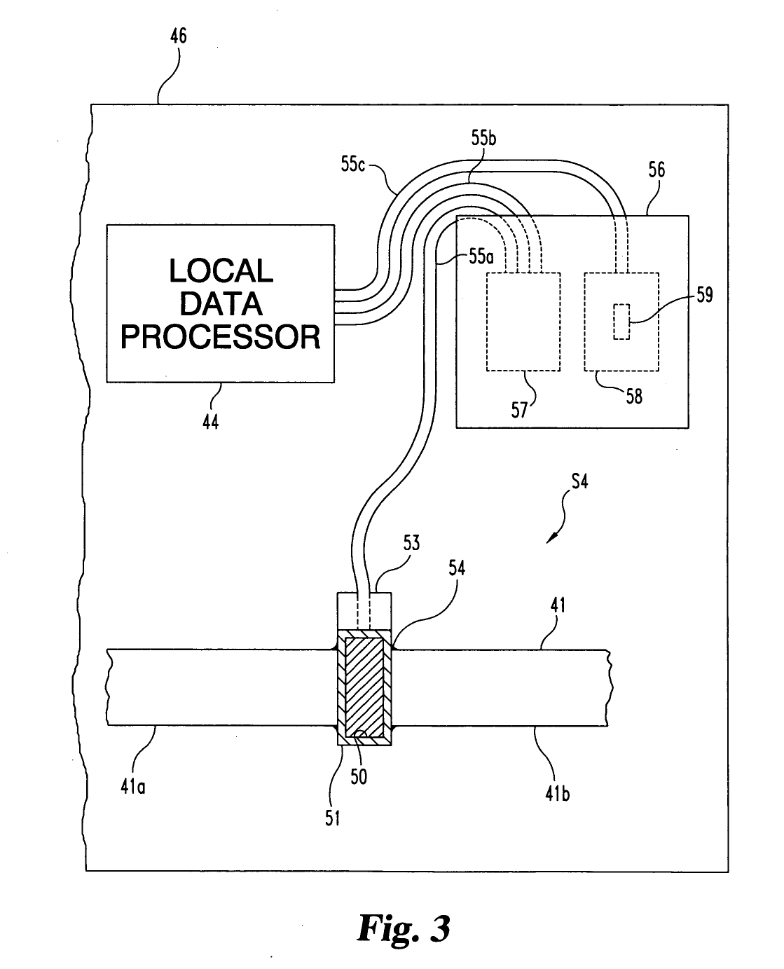

FIG. 3 illustrates radiation sensor S4. In one embodiment, radiation sensor S4 includes a Geiger-Müller counter tube 50, or other suitable radiation detector, that exposed to the flow of water through a pipe 41. The flow of water enters radiation sensor S4 via inlet section 41a of pipe 41 and exits via outlet section 41b of pipe 41. Tube 50 is generally centered in and spans across the pipe, for example extending between opposed walls and through the centerline of the pipe. Centering the tube 50 in the pipe, or at least positioning the tube such that water passes completely around the tube 50, serves to increase the exposure of the tube to the water. Increasing the exposure to the water increases the chance that any radiation in the water will be detected. In certain embodiments, tube 50 is secured and sealed with an Epoxy material 54 at the juncture between tube 50 and pipe 41. In an alternative embodiment, O-rings can be disposed about tube 50 to substantially prevent water flow out the section of pipe through which Geiger-Müller counter tube 50 is inserted and removed. In certain embodiments, tube 50 is inserted in a section of pipe which is coupled at both ends to pipe 41 to permit flow of water through sensor S4. Tube 50 can be provided with a rubber coating 51 to protect tube 50 in the flow of water. In one embodiment, Geiger-Müller counter tube 50 is dipped in a liquid rubber substance and allowed to dry, creating coating 51 thereon. A plastic cap 53 can be positioned over tube 50 to protect the Geiger-Müller counter.

Tube 50 is connected, via a wired connection 55a, to a reference electrode station 56 positioned at a location open to atmospheric conditions. More specifically, tube 50 is connected to test circuit 57. Station 56 includes a reference Geiger-Müller counter tube 59 operable to detect and measure background radiation. Reference tube 59 is operably connected to a reference circuit 58. Test circuit 57 and reference circuit 58 are operably connected to local data processor 44 via wired connections 55b and 55c, respectively. The data analysis performed by local data processor 44, with regards to radiation detection, is a function of data collected from tube 50 as well as reference tube 59. In one embodiment, station 56 is mounted onto panel 46.

Regarding sensor S1, pH meters measure the acidity or basic nature of liquids. A pH of 7 is neutral, in that the number of H+ ions equals the number of OH— ions in the water. If the H+ ions become predominant, the water becomes acidic. If the OH— ions become predominant, the water becomes basic. pH effects the disassociation of certain ions, including those of chlorine. Free chlorine detection requires pH compensation for the chlorine sensor, so if elemental (gaseous or liquid) chlorine is used as the disinfectant, a pH meter will also be required.

Regarding sensor S2, various types of chlorine and chorine compounds are used in drinking water distribution systems to maintain disinfection. The chlorine oxidizes and kills biological contaminants in the water, so drinking water utilities must maintain a chlorine residual concentration throughout the distribution system to prevent re-population of the water by bacteria, viruses, protozoa, and fungi. The introduction of biological contamination into the distribution system will result in a reduction of the chlorine residual. Chlorine is an aggressive oxidizer and readily oxidizes many chemicals, as well as biota. Introduction of bacteria or nicotine in the water will cause the chlorine content to drop due to its oxidation of the introduced contaminant. In other words, the chlorine becomes bound up chemically in the process and is no longer available for further oxidation. In this way, the introduction of biological and certain chemical contamination into a water supply changes the chlorine content, and thus the presence of these contaminates can be inferred from the measured chlorine level. In other words, the reduction of chlorine content is an indirect measurement of the presence of bacteria or nicotine, for example.

Regarding sensor S3, oxidation reduction potential (ORP, or REDOX) is a measurement of the potential of the water to oxidize (add electrons) or reduce (add protons) chemicals. ORP levels generally track with the chlorine concentration. A high level of chlorine will be reflected by a positive reading in millivolts for ORP. As the chlorine becomes unavailable as it oxidizes, the ORP will drop. As long as there is a sufficient amount of chlorine to oxidize contaminants, there is some defense against the addition of certain types of contamination. Generally, ORP sensors are inexpensive, long-lived, and require low maintenance. The chlorine sensors require periodic calibration, electrolyte replacement, and probe replacement. The use of ORP with chlorine as a key parameter adds validation to the detection process. The following examples of scenarios highlight this relationship. In a first scenario, a chlorine value decreases, and the ORP remains steady. This indicates that the chlorine sensor may have failed, and there is probably enough chlorine residual due to the oxidation potential. The chlorine sensor should be examined. In a second scenario, both the chlorine and ORP values drop. This validates the presence of a contaminant, as the oxidation potential drops as the chlorine oxidizes the contaminant.

Regarding sensor S4, radiation detectors measure the amount of radiation in the water. Water is an effective insulator against low-energy radiation. Tube 50 is designed to detect trace levels of radiation which can be present in water. Alpha and Beta particles will not travel very far in water, so these particles are not of concern. Gamma radiation travels through water, and can be detected. It is certainly possible to create a salt from a radioactive metal and dissolve the radioactive salt in the water. These salts may also increase the conductance of the water, so conductivity may also rise in a measurable manner. Additionally, there is always background radiation which can be detected by reference tube 59. Local data processor 44 can determine radiation in the water that is above background level using data collected from tube 50 and reference tube 59.

Because of the broad range of detection capability represented, it is believed that chlorine, ORP, pH, and radiation should take their places as primary components of the water quality baseline. These four parameters, measured by sensors S1-S4, will react to water quality changes due to a wide range of chemical, biological, and radiological (CBR) contaminants.

Despite the numerous different contaminants in the world, a few basic parameters, and their relationships to each other, can be indicative of overall water quality. It has been determined that two or more sensors can be useful in determining water quality by analyzing the relationship created by the data received from each sensor. For example, when data from a first sensor goes up and data from another sensor goes up, this might be indicative of a common water quality situation. However, if data from the same first sensor goes up and data from the same second sensor goes down, this might be indicative of a more severe contamination situation. By continually analyzing the data generated from monitoring chlorine, pH, ORP, and radiation throughout the water supply system, and by using software to analyze and verify relationships, significant changes in water quality can be detected and interpreted. The first three parameters, chlorine, pH, and ORP, can be monitored with current technology featuring an “all in one” concept, such as collective sensing device 40, reducing the cost, space, and maintenance required.

In general, three types of contamination affecting environmental conditions, including water quality, are chemical, biological, and radiological (CBR). The baseline should include a set of parameters that will detect the evidence of as many of these contaminants as practical. It has been determined that chlorine and ORP reacted strongly to the injections of nicotine (a nerve toxin), aldicarb (a pesticide), arsenic trioxide (an herbicide), and E. coli (bacteria). The chlorine oxidized these contaminants and the ORP dropped, accordingly, validating the chlorine data. The success in detecting a wide range of contaminants suggests that monitoring these two parameters provides a solution for detecting the evidence of contamination. ORP, alone, offers an effective monitoring solution, but water quality surveillance benefits from additional information generated by other sensors, as well. If free chlorine is used as the disinfectant, pH must also be measured. If the disinfectant is chlorine dioxide or chloramines, the pH meter may be left out. The use of an in-pipe radiation detector completes the baseline. Radiation added to water may not have a strong influence on the other parameters, but it will be detected by a radiation detector, such as sensor S4.

However, it should be appreciated that other parameters beyond the four basic ones noted above can be readily monitored in near-real time with one or more monitoring units 22, such as conductance, turbidity, dissolved oxygen (DO), and temperature. Conductance measures how well the water conducts electricity. This is an indirect method of determining the total dissolved solid (TDS) concentration in the water. These dissolved solids are usually in the form of disassociated ions, and these ions facilitate the conducting of electricity. Turbidity measures how turbid, or cloudy, the water is. Particulate matter or colloidal suspensions will filter out light and cause the water to become turbid. It is possible that biological or chemical contamination could cause the turbidity to rise in certain cases. Dissolved oxygen (DO) measures the amount of dissolved oxygen in the water. The ability of water to hold dissolved gas is temperature dependent. Temperature affects the water's ability to hold gases such as chlorine and oxygen. Cooler water can hold more dissolved gases than warmer water. Heat causes the molecules to move around quicker, allowing the gas to escape. In some cases, chemical and biological contamination could cause the oxygen levels to drop because of oxygen demand. Temperature affects the water's ability to hold gases such as chlorine and oxygen.

Additional parameters and/or sensors could also be employed that are more suited to advanced monitoring. Examples of these include particles, nitrates, volatile organic compounds (VOCs), total organic carbon (TOC), phosphates, and specific ions that could be measured via system 20. A particle counter measures particles in the water. Some counter devices are very sensitive, able to count very small particles. A nitrate sensor measures the concentration of nitrates in the water. Nitrates may be related to chemical decomposition, agricultural runoff, or explosives. A volatile organic compounds (VOCs) sensor measures specific chemicals like hydrocarbons, trichloroethylene (TCE), for example, and other volatile chemicals. Often associated with pollution of groundwater, these chemicals represent readily available sources of contamination. VOCs are detectable and can be identified using gas chromatographs. Portable chromatographs are currently available and are becoming more affordable. Measuring total organic carbon (TOC) involves measuring the total amount of carbon in a water sample. TOC indicates the presence of organic compounds, including those making up biological contamination, by the amount of carbon present. A mass spectrometers (MS) measures chemical concentration and identifies the chemicals. However, it should be appreciated that this device is currently expensive and difficult to operate. Another possible device is a UV absorbance spectrometer. Ion-specific electrodes measure certain ions such as arsenic, copper, lead, etc. In many cases, pH must be adjusted to allow for direct detection and quantification of the ions. Table 1 below summarizes some attributes of these parameters, sensors, and analyzers and indicates whether they are more suitable for basic (i.e. low cast, multiple locations) or advanced (higher cost, more centralized) monitoring.

TABLE 1

| | | | | | | |
|---|---|---|---|---|---|---|
| | | | Relative | Maintenance | Impacted by | Identifies |
| Sensor Analysis | Basic | Advanced | Cost | Requirements | Contaminant | Contaminant |

Chlorine

| Free Chlorine | X | Medium | Medium | Chemical, | No |
|---|---|---|---|---|---|
| | | | | Biological | |
| Total Chlorine | x | Medium | Medium | Chemical, | No |
| | | | | Biological | |
| Chlorine Dioxide | x | Medium | Medium | Chemical, | No |

| | | | | | Biological | |
|---|---|---|---|---|---|---|
| ORP | x | | Low | Low | Chemical, | No |
| | | | | | Biological | |
| Conductance | x | | Low | Low | Chemical, | No |
| | | | | | Biological, | |
| | | | | | Radiological | |
| Radiation | x | | Low | Low | Radiological | No |
| pH | x | | Low | Low | Chemical | No |
| Turbidity | x | X | Medium | Low | Chemical, | No |
| | | | | | Biological | |
| Ultraviolet Absorbance | x | X | Medium | Medium | Chemical | Yes |
| Spectrometry | | | | | | |

| Dissolved Oxygen | X | Medium | Medium | Chemical, | No |
|---|---|---|---|---|---|
| | | | | Biological | |
| Temperature | X | Low | Low | | No |
| Particle Counter | X | Medium | Medium | Chemical, | No |
| | | | | Biological | |
| Nitrates | X | Medium | Low | Chemical | Yes |
| VOCs (GC) | X | High | Medium | Chemical | Yes |
| TOC | X | High | Medium | Chemical, | No |
| | | | | Biological | |
| Mass Spectrometer | X | High | High | Chemical | Yes |

It is to be appreciated that all of the sensor technologies listed in Table 1 (and others) could be employed with system 20 in an attempt to detect contamination. However, in practical applications, this would rapidly prove to be very costly and still might not detect all contaminants of concern. In fact, a myriad of sensors could be employed at a high cost and a specific contaminant still might remain undetected.

As discussed previously, individual technologies currently exist to monitor individual certain chemical, physical, and radiological parameters of concern to the security and operational performance of a water treatment and distribution system. Some parameters that can be monitored “on-line”, i.e., in real time, continuously, or off-line relatively quickly, include pH, oxidation reduction potential, chlorine content, and radiation. Other on-line parameters include hardness, heavy metals (Cd, Pg, C, Hg), temperature, cyanide, dissolved oxygen, nitrates, conductance, ammonia, turbidity, air quality (CO, CH₄, SO NOx), flow, total organic carbons, pressure, organophosphates (MS), other toxic agents (MS), ultraviolet light intensity, volatile organic chemicals, pumps, valves—on-off status, and halogens (C12, Br).

Chemical contamination and radiological contamination present direct opportunities for success in their detection. Many chemicals can be detected instantly using ion-specific sensors and analyzers. These fit in the “on-line” category, in that they can be detected instantly in the medium of concern. Those that do not allow for real time detection can be detection using “off-line” technologies such as mass spectrometry or chromatography. In addition there are analyzers that target specific chemicals and detect and quantify them using titration or other means. These “off-line” methods can often perform their analyses and deliver appropriate data rather quickly—within a few seconds, or so. A disadvantage with off-line technologies is that they are usually more costly than on-line technologies due to complexity and proprietary issues. A complication with some off-line technology is that samples must be prepared prior to analysis. For example, in order to analyze water for cyanide content, the pH of the sample must be raised to between 11 and 13. By definition, the United States Environmental Protection Agency (USEPA) classifies this sample as process waste and, due to its pH, hazardous. Because of this classification, the sample cannot be placed back into the stream of water from which it was taken—it must be treated or disposed of separately. The key to success here is to stimulate development of cheaper, quicker detection equipment covering a broad range of chemical threats.

Radiation is somewhat easier to detect. Gamma rays travel readily through water and radiation detection probes can be inserted in the water to detect the presence of radiological contamination. Alpha particles cannot be detected because they do not travel very far through the water to reach the detector. In the case of Gamma radiation, probes (such as sensor S4) can be inserted into the water. There is always background Gamma radiation from “Cosmic rays”. This background “noise” is accounted for by the utilization of reference tube 59 and the data collected therefrom can be used as a baseline. If any sudden or significant increase in Gamma radiation is detected in the water, system 20 can notify appropriate personnel and either shut off the water supply or activate effective treatment technology to remove the contamination. Radium, Uranium, and Plutonium are, in the end, simply metals that are radioactive. These metals are soluble in water to varying degrees and are often found at unsafe, though natural, levels in water wells in the American West. There is enough highly radioactive material unaccounted for in the world to generate significant concern as to its whereabouts and how it might be used in terrorist attacks. The use of such material in “dirty bombs” has been discussed, wherein conventional explosives would be used to scatter highly radioactive material over an area to make it unsafe. Another possibility is the use of chemical salts of these metals to contaminate water supplies.

The manner in which contaminants affect certain basic chemical and physical parameters of an aquatic regime is an important aspect of system 20. For example, the introduction of chemicals into the water might cause the pH to change. Many chemicals will cause the amount of total dissolved solids (TDS) to rise and, in turn, cause the conductance (how well the water conducts electricity) to change. Certain chemicals and biological contamination will lower the amount of dissolved oxygen in the water. Certainly, chemical and biological contamination can make the water more turbid (cloudy). Biological contamination will place a demand on the chlorine residual, reducing it. Radiological contamination will raise the conductance and can be detected directly with appropriate technology.

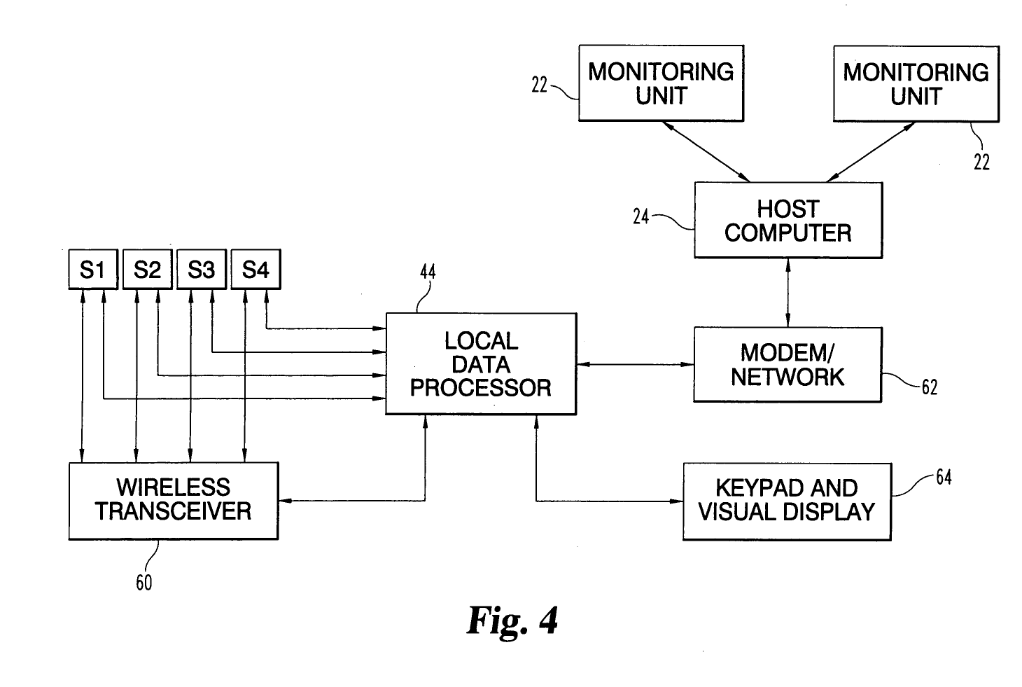

FIG. 4 depicts a flow chart illustrating the path ways of communication between sensors S1-S4, local data processor 44, and host computer 24. Local data processor 44 can be capable of managing information from sensors S1-S4, using diagnostic logic, whether receipt of this information is by wireless radio frequency (RF) or a wired connection. If the communication is wireless, data is transferred from sensors S1-S4 to a wireless transceiver 60, which wirelessly communicates with local data processor 44. Local data processor 44 communicates to host computer 24 via a modem/network 62. Local data processor 44 can be capable of both RF and wired communication with host computer 24, or another type of central control system. Further, local data processor 44 can be capable of transmitting both digital and analog information, and communicating with computer-based systems of management of information. In one embodiment, host computer 24 communicates with multiple monitoring units 22. Additionally or alternatively, local data processor 44 can be accessed with a keypad and visual display 64 for on-site access to local data processor 44. In one embodiment, local data processor 44 can be powered easily with ambient power-such as solar, hydraulic, and rechargeable batteries.

Baseline values for these parameters are established, for example by programming them into the monitoring system. Diagnostic logic of local data processor 44 involves comparing readings to the baseline values and detecting significant fluctuations or changes. Additionally, diagnostic logic involves comparing data from two or more sensors together to analyze their interrelationships. Backup analyses can also be performed to discern the importance of the change and, if deemed significant, the event would be reported and the water could be shut off at the point of detection. The process described above is sometimes termed “data fusion” and is built upon an historic foundation dating from multiple regression techniques to data mining and fuzzy logic, all utilizing the diagnostic logic functions found within local data processor 44.

The RF capability within system 20 should be of the appropriate range, strength, and frequency to perform these tasks over both short and medium distances (700 feet-2 miles). Additionally, attenuation of RF should be taken into consideration for various applications, so repeaters might be needed in many cases, such as in mines, large buildings, and underground in landfills and pollution remediation situations. Additionally, local data processor 44 can be capable of operating in the field using alternative energy sources, such as, solar power, microwave radiation, and, even, wind power. Local data processor 44 can also be capable of operating in a Local Area Network (LAN). Additionally, in other embodiments, system 20 operates on a smaller scale with limited operational capabilities. Based upon the environment and tasks involved, system 20 is tailored to meet the communication needs and limitations of the application. For example, the RF unit needed might have a fixed frequency or be of a spread spectrum type and have a range from just a few hundred feet to several miles.

Regarding sensors S1-S4, local data processor 44 can receive wireless or wired input from sensors S1-S4 generating (but not limited to) the following: a current (4-20 milliamp signal), a voltage, a resistance, or a digital signal (parallel or serial—RS-232, RS-485, etc.). Sensors S1-S4 can be powered by AC or DC voltage, which could be generated by batteries, solar, wind, water, or other power, as well as conventional means. Additionally, system 20 can include a battery backup power source in the even of a power failure. In one embodiment, the battery backup power would be operable to send a message to appropriate personnel reporting the power failure. Further, regarding data input, local data processor 44 and wireless transceiver 60 can communicate using digital and analog information.

System 20 includes software associated with local data processor 44 as well as host computer 24, or another such central computing system, that controls system 20 and its internal operations. Local data processor 44, as well as host computer 24, are programmed with custom, application-specific programs concerning sensor inputs, data analysis, communications, local and remote actions, decision making, and other application-specific activities.

System 20 supports two-way wireless and/or wired communications in a manner as would occur to one skilled in the art. There exists radio frequency licensed and unlicensed radio systems. Coupling system 20 with a meshed radio network maximizes reliability and flexibility. The communications network associated with system 20 could include high-speed broadband, greatly enhancing the communications capabilities. Additionally or alternatively, the communications system associated with system 20 could include satellite communications, involving low earth orbit, geosynchronous, and/or high-speed broadband communications. Additionally or alternatively, the communications system associated with system 20 could include cellular communications directly through the use of a CDPD or other modem, or indirectly through Ethernet to Internet to Cellular path. Additionally or alternatively, the communications system associated with system 20 could include Ethernet communications, such that local data processor 44 and host computer 24 will contain embedded programming allowing communications with various legacy systems. Additionally or alternatively, the communications system associated with system 20 could include communications flexibility through easily changed plug and play communication modules. Further, the software associated therewith can automatically recognize the communications mode installed. In one embodiment, local data processor 44 and host computer 24 allow for dual communications at any time.

Through the utilization of two-way communications, local data processor 44 can be configured remotely from a central location. Local data processor 44 should house an embedded Internet web page that defines and describes the parameters, and these definitions and descriptions, along with set limits set of the parameters for specific sites of installation, should be remotely accessible and configurable. This web page can be accessed remotely to view the current status of system 20 and to change the settings if needed. Additionally, the receiving unit at central locations, such as water plants, will be configurable to work with legacy systems and protocols such as Profibus, Metsys, Lonworks, Intellution, etc. This takes guesswork out of integrating system 20 with existing systems and will be very appealing to plant operators and municipal buyers. Further, local data processor 44 can have considerable computing capability in order to have a system capable of utilizing distributed logic, creating an intelligent network of sensors, analyzers, communications, and actuators. This allows for continuous, real time data analysis and instant notification if an event occurs. It also benefits overall system 20 performance by mining the data to determine information that needs to be communicated and that which does not. By installing sufficient computing power in local data processor 44, the incorporation of data fusion software can be done in the future to provide assessment of relational changes of the monitored parameters. In one embodiment, local data processor 44 is able to notify if external power failure or tampering occurs. Two-way communications will allow remote diagnostics of the system.

Once accurate, sensitive, and reliable sensors S1-S4 have been selected and installed, the signals generated by sensors S1-S4 can be acquired and converted into useful data. Many sensors generate an analog output in milliamps or millivolts, and this analog data must be converted to digital data to facilitate analysis and communications. This conversion must be performed with the best resolution possible to maintain the accuracy and integrity of the data. Microprocessors, such as local data processor 44, acquire the data by taking a reading from sensors S1-S4 on a periodic basis. The use of distributed processing creates efficient, intelligent networks that perform analyses and data management locally, and communicate critical information. The data should be stored in a database for management and to allow for historical analysis. Local data processor 44 may compare data received from sensors S1-S4 to historical data or trends to determine an action based on the historical data or trends. Additionally, local data processor 44 may change baseline references values, with which to compare to data received from sensors S1-S4, periodically based on historical data and trends. Current values of the parameters being monitored can be displayed in a web-based format, allowing the web page to be served up to the Internet or local area network (LAN) from local data processor 44 or by a network server. In a preferred embodiment, local data processor 44 is associated with an Internet Protocol (IP) address to maximize efficiency.

The user can access the data by connecting to the IP address of each local data processor 44 of a monitoring unit 22 either through the Internet or a secure LAN. Monitoring unit 22 can be accessed directly or automatically with a central computer, such as host computer 24. The embedded software in local data processor 44 analyzes the data from sensors S1-S4 for compliance with set limits and notifies if any parameter is out of acceptable range. Local data processor 44 can store data until it is downloaded remotely or locally into a database for analysis. Ideally, the data from all parameters being monitored will be stored to capture one year's data. Hourly, daily, weekly, and monthly averages of the values will be calculated to determine the “baseline”, or normal range, of each parameter for each site during various times of the year. This baseline becomes the basis to which current values are compared. The values of some parameters may not change much over time; others may change significantly due to seasonal variations, weather, and operational adjustments.

The source of drinking water can affect how much the water quality changes throughout the year. Surface water sources such as rivers and reservoirs are much less static in water quality than are underground sources. Well water tends to be fairly constant in water quality, though minor variations will occur. Surface waters are subject to the impacts of seasonal changes. Turbidity (cloudiness), temperature, and chemical contamination are affected by seasonal variations. Precipitation runoff, itself affected by land-use practices such as farming and construction, can contribute to the degradation of surface water sources. Eroded soil, pesticides, herbicides, fertilizers, and biodegradable vegetable matter can place additional demands upon the treatment plant. Seasonal temperature fluctuations will be reflected in the water temperature and will affect the water's ability to hold gases like oxygen and chlorine in solution. The warmer the water, the less gas it can hold. Most utilities use more chlorine during the warmer months for this reason.

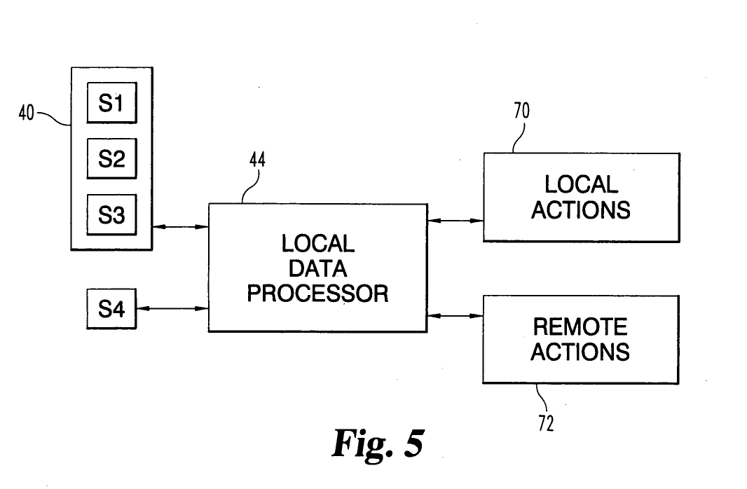

FIG. 5 illustrates a flow chart in which local data processor 44, based on data received from sensors S1-S4 and analyzed utilizing diagnostic logic incorporated in local data processor 44, is capable of initiating various actions, including local actions 70 and/or remote actions 72 in response to the data received and analyzed. Additionally or alternatively, host computer 24 is also able to initiate local actions 70 and/or remote actions 72. Some examples of local actions 70 include, but are not limited to, initiating an audible alarm, fan control, process control, valve control, pump control, pH adjustment, ventilation control, alarm system control, assembly line control, machine adjustment, automatic dialing of telephones, staff notification/alert, etc. Some examples of remote actions 72 include, but are not limited to, two-way communication with remote computing systems, which allows a human or a computer to make adjustments in real-time, and communication with other devices and/or monitoring units 22 allowing for system coordination and control.

Other examples of local and remote actions, 70 and 72, respectively, are as follows: log in the data, compare the value to acceptable values, determine compliance or noncompliance, communicate either wirelessly or via wire laterally with other monitoring units 22, communicate either wirelessly or via wire with a higher level computer, transfer analog or digital data, make decisions concerning necessary local action if monitored values are out of compliance, take necessary local action, elevate decision making process to higher level computer if necessary, send batches of logged data to storage, interdict processes, sound alarms, display values, accept input from keypad, accept programming only from external authorized sources, etc. Additionally, local data processor 44 can be capable of performing one or more response activities, such as local actions 70 and remote actions 72, per each set of data input.

Once a threat is detected, the water treatment plant and those persons served by the water system must be protected from the threat through negation, mitigation, notification of the threat and/or by supplying an alternative source of potable water. Negation of a threat means the elimination of the possibility of the threat disrupting the ability of the system to provide a safe and reliable supply of water. Mitigation means the lessening of the capability of the threat to disrupt the supply. A bacterial contamination could be negated through detection and purification, e.g., ozonation, chlorination, pasteurization. A chemical threat could be mitigated by chemical or physical treatment to reduce its potential impact to a safe level. Radiological contamination can be removed through sophisticated ion-exchange units, though this will create radioactive waste at some point in the process. Concurrent with negation or mitigation activities is notification of appropriate personnel, local and otherwise, of the detection of the threat and the action taken to negate or mitigate it. Depending on the threat and the size of the plant, an alternate means of water treatment might be necessary to provide a continuous, but reduced, supply of potable water. This alternate means would include technology specific to the destruction of the detected threats and would treat the water to remove them.

It is envisioned that a series of regional “clearinghouses” would receive notifications, alerts, and/or alarms remotely and disseminate it to appropriate authorities, including local and national centers. A primary function of the clearinghouse activity would be to look for any broad patterns and coordinate responses. A national clearinghouse can be used recommended to facilitate the overall coordination of system 20, provide security, provide redundancy, and direct any national response. New and duplicate lines of communications can be established to allow commanders, agency heads, operations personnel, emergency workers, and others to communicate. Two disparate communications links can be established at the water plants and the clearinghouses to ensure that critical information is received and acted upon available means of communication are radio, satellite, Ethernet, Internet, telephone, cellular networks, and other local area networks (LANs) and wide area networks (WANs). In one embodiment, the communications links include one wireless and one wired link. The data can be manifested locally in the plant operations office and, possibly, at the municipal office responsible to the public for the water system, i.e., the Board of Public Works, Mayor's office, etc.

Local authorities can be notified immediately of detected threats and security breaches. Notification can be performed both automatically and personally. Local data processor 44 and/or host computer 24 can send email messages to monitoring centers and cell phone text messages to appropriate individuals. If necessary, audible alarms can be sounded. Physical security monitoring systems can, most likely, use personal telephone call for notification of appropriate individuals and organizations. In any case, redundancy in communications can be established in the event one communications link is inoperable.

The allowable ranges of values established for the baseline should be selected based on the normal variations discussed above. Local data processor 44 and/or host computer 24 can allow for the ranges to be determined based on historical values captured over time, such as described above. Knowing the normal ranges of each parameter at each site, and adjusting the acceptable ranges based on the normal ranges during the year, is an effective way to look for abnormal water quality and the evidence of contamination. A notification should occur if a parameter goes slightly out of its normal range. A notification should also occur if a parameter goes significantly out of its normal range. The notifications should reflect the significance of the change, however. A slight variation from normal should be taken into account and investigated. A significant change, one that causes the water to exceed drinking water standards, for example, requires a response to determine the cause and mitigate the problem. The adjustments to the acceptable ranges can be done manually and remotely, or automatically, as local data processor 44 consults a history database for that particular monitoring unit 22.

Some utilities have multiple sources of water. This, coupled with complex hydraulics, can create a system where the baseline is so variable from day to day that another form of data analysis must be used. In such a case, the source waters would be monitored for applicable parameters such as, but not limited to, dissolved oxygen, ORP, phosphates, nitrates, organics, turbidity, radiation, and temperature. Algorithms would be developed to analyze the data and look for trends and make statistical comparisons to determine whether the water quality is in compliance. This type of monitoring requires the use of self-learning programs that can be embedded in the monitoring unit 22

Many utilities may wish to have a computer, such as host computer 24, continuously monitoring each monitoring unit 22. Software on host computer 24 will enunciate any alerts or alarms, calling the operators attention to the current situation. The software can also report system malfunctions, send emails and pages to selected persons, require acknowledgement of the notification, record the action taken, and print the activity log for the event. Additionally, in one embodiment, operations/security personnel can enter normal operational activities that might affect water quality.

Generally, three very different areas of water systems should be monitored, including water sources, water treatment plants/processes, and water storage/distribution systems. Surface water supplies are especially vulnerable to contamination. A system providing physical security and water quality monitoring can be installed in addition to system 20 to protect undeveloped reservoirs. Advanced video technology exists that takes note of any changes in its view. If someone enters into the reservoir area, the video can record the event and communicate the intrusion. The water quality can be monitored in a pattern that covers the access to the water intakes of the reservoir, or other such water source.

Water treatment plants are not always near the source of the water. The sources are, in some cases, many miles from the plants. In order to insure no tampering or contamination has occurred, water quality monitoring can be performed as the water enters the plant as well as when it leaves by utilizing one or more monitoring units 22. Various operational and security parameters could be monitored throughout the plant to maximize the operations and detect contamination.

Once the water leaves the plant and enters a distribution system the opportunity for contamination still exists. In order to protect those served by the water systems, various points throughout the distribution system, including elevated storage tanks, can have monitoring units 22 installed. Installation of effective monitoring in these three areas of the water system will provide as much protection to the water system and the populace being served as possible.

System 20 integration will result in a triage approach to detection, actuation, and notification. As long as no problems are detected, there should be no action or notification. Only data of significance that indicate problems or needed action should be reported; otherwise, the networks would be bogged down with unnecessary information. Therefore, the software will be programmed to vigilantly search for situations that should not be present under any circumstances. Information sent to regional clearinghouses can create the necessary notification messages and can be placed in a database for further analysis and data mining. Locally, if system 20 indicates a situation of concern in the water system, the water could be shunted through a water filtration and purification system or other specialized treatment system for mitigation of the threat, and a considerable stream of potable water could be maintained.

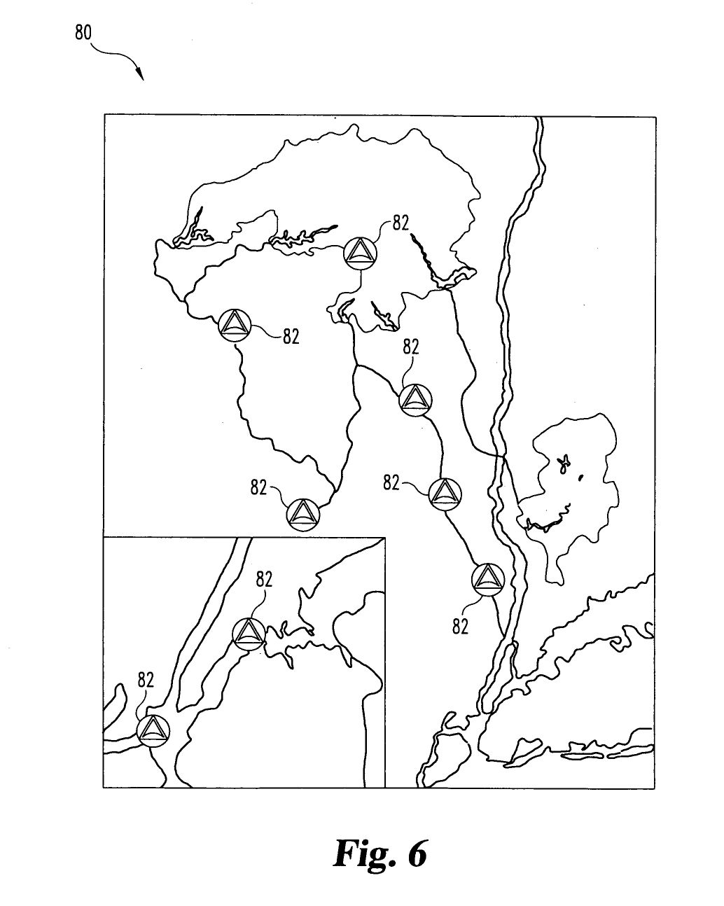

FIG. 6 depicts a computer illustrated map 80 including icons 82 representing monitoring units 22 of system 20. The icons 82 show the relative location of each monitoring unit 22 in an area. Additionally, in one embodiment, each icon 82 is color-coded depending on the severity status of any alerts and/or alarms associated with parameters evaluated at a given monitoring unit 22.

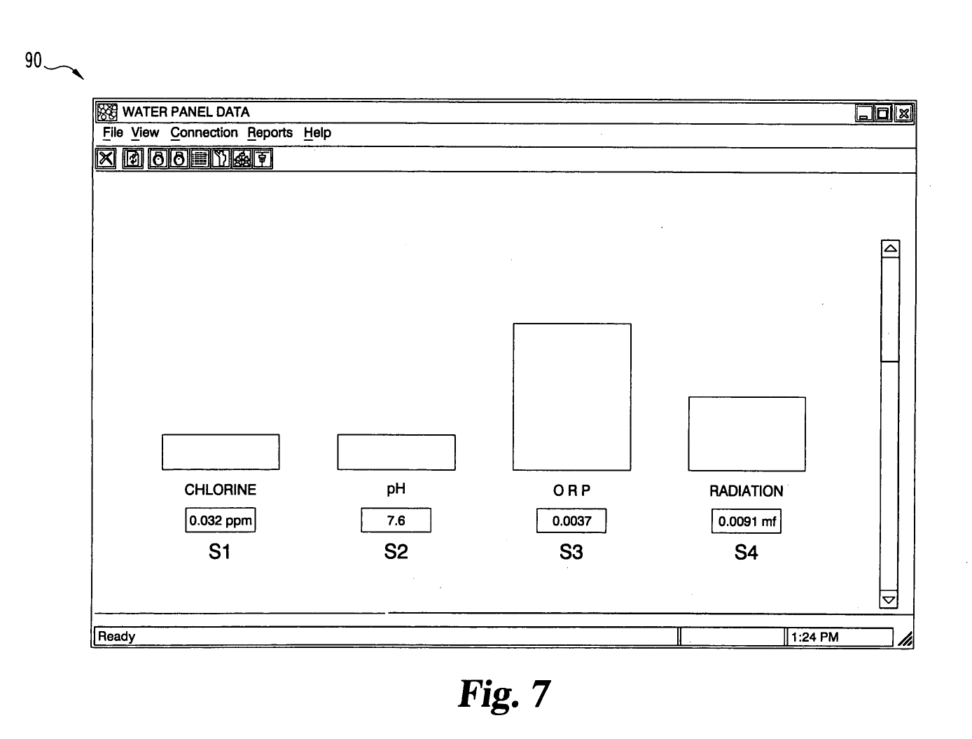

FIG. 7 illustrates a display 90 showing information associated with a monitoring unit 22. In one embodiment, display 90 is retrieved by selecting with a mouse or other such device an icon 82 on map 80 representing a monitoring unit 22. The display 90 shows the data collected and analyzed by local data processor 44 at the selected monitoring unit 22 and observed on host computer 24. The use of the colors “green”, “yellow”, and “red” can be incorporated to indicate “within limits”, “slightly out of normal range”, and “unsafe conditions”, respectively, allowing for non-technical users to easily understand the information. In one embodiment, an alert issues for a yellow condition, and an alarm issues for a red condition. Additionally, in one embodiment, an alarm issues if two or more parameters are associated with a yellow condition. The user can acknowledge the notifications and turn off the audible signal. The notification and action taken can be automatically recorded and printed.

Additionally or alternatively to system 20, a modular water production system that filters and purifies water without the use of supplied chemicals could be implemented. Such a system can be deployed in a mobile as well as a stationary version. The purification is done by a proprietary combination of three processes, one of which involves the on-site generation of a strong oxidant. Such a system can be designed to destroy most or all pathogenic organisms as well as volatile organic chemicals. It can remove heavy metals and can most likely mitigate threats from organophosphates through oxidation.

In one embodiment, a supplemental water filter and purification system is designed to be simple to operate and maintain and to be as logistically independent as possible. It is envisioned that, among the many applications for such a system, it could be employed as a back up to system 20 in a water plant. Once a biological or chemical contamination is detected, the water source would be diverted to the filter and purification system to be treated, thus ensuring a continuing supply of water until the filter and purification system eliminates the contamination. In one embodiment, such a system is modular and can be duplicated and scaled to meet the emergency needs of the populace served. The mobile version of the system would be easily deployed to supply drinking water in the field in the event of a catastrophe. Powered by a diesel generator, the unit is, otherwise, logistically independent. Sensors integral to the filter and purification system can allow for remote monitoring for performance assessment and control.

Additionally or alternatively to system 20, physical security of the water sources, plant facilities, and distribution system could be implemented to protect these facilities from illegal entry, fire, tampering, theft, and other surreptitious activity. By denying access and using effective surveillance techniques and technology, the potential for intentional contamination of the water is reduced. Physical security and process security go hand-in-hand to provide a comprehensive system of vigilance and protection. Monitoring systems are available to perform the necessary monitoring of physical security. Breaches in physical security would be detected and the proper authorities would be notified as to the status of the breach, fire alarm, etc.

With regard to visual monitoring of facilities, the solution has historically been to use video cameras that transmit images to monitoring rooms where groups of people watch the screens for suspicious or unauthorized activity. “Smart” video systems are now available that recognize changes in the scene and analyze the information to determine if it needs to be reported. These systems eliminate the need for employing people to stare at monitors for hours, and the amount of archived tape to be stored is drastically reduced. The use of smart video systems is facilitated by the ability to receive the digital data from the cameras and transmit it, along with notifications, to appropriate personnel.

System 20 has various other possible applications in addition to water quality monitoring. The following examples will be used to demonstrate the versatility of and possible applications for system 20 described herein. System 20 may be particular useful in computer room monitoring, tank overfill protection, integrated laundry store monitoring, integrated industrial monitoring, contaminated area monitoring, landfill monitoring, secondary contaminant monitoring, worker safety monitoring, and hazardous environment monitoring.

A computer room monitoring system is a basic system. The parameters to be monitored include (but are not limited to) temperature, humidity, and presence of water leaks. Typically, the system can communicate with a computer-based data logging system, and be able to sound an alarm and automatically dial responsible persons if the need arises. There can be both wireless and wired applications.

A tank overfill protection system monitors levels of liquids in storage tanks, sensing preset height limits and taking action to shut off incoming, liquid and open drain valves, if necessary. This system can be applied in a range of complexity from a simple addition built in to a hot tub to prevent overflow, to much larger, more critical applications such as prevention of overfilling of a large storage tank containing hazardous liquids. The sensors in the latter case may need to be able to survive in harsh environments and that will impact their configuration. Status and control display panels can be included and the system can be expanded to monitor other parameters, such as, temperature and pH of the contents of the tank, and flow in or out of connected piping.

An integrated laundry (store) monitoring system allows Internet dialup and remote monitoring of a laundry or other commercial facility and can include motion detection, liquid leak detection, gas leak detection, video display of store activity, temperature sensing, etc. In addition, automatic valves can control separate areas in the laundry store subject to experience leaks, such as, separate banks of washing machines, water softeners, and water heaters, so that these discrete areas can be independently shut down. Communications between the various monitoring functions in the laundry can be wireless.

An integrated industrial monitoring system is a communication and control link between arrays of sensors and central control in industrial environments. The four major industrial regimes—process control, worker safety, environmental compliance, and quality assurance—are monitored by sensor arrays for appropriate parameters. These monitoring sensors are both fixed and portable, and communicate by wire and radio, respectively. A processor, such as local data processor 44 or host computer 24, receives, processes, and takes action upon, information received from the sensing system.

A contaminated area monitoring system can be used primarily in areas where hazardous chemical spills have occurred. A typical installation consists of an array of sensors monitoring the soil around where a leaking underground storage tank has been removed. Sensors capable of monitoring for the presence of hydrocarbon vapors or other chemicals in soil or water are used to detect contaminant concentrations and communicate with a processor/microcontroller, such as local data processor 44. Local data processor 44 then records the concentration of the parameters, providing a record of any remediation or migration of the pollutants involved.

A landfill monitoring system consists of a complex grid of sensors installed underneath the liner of a sanitary, special waste, or hazardous waste landfill. The sensors used can be selected specifically for each application based on the material in the site, and give warning about and location of a leak in the landfill liner. As the sensor arid can be buried underground for a long rime, it must be designed to withstand the weight of overburden, vibrations caused by heavy equipment, shifting about of the earth, and any other harsh environmental considerations. The sensor grid will be connected by wire, so the connective system can also have to be capable of functioning for a long period of time under the adverse conditions described above. Another feature will be the ability to replace and repair sensors and wiring through conduits without digging up the landfill. The sensors used can monitor for direct evidence of leaks, as well as, for indicators of leaks, i.e., pH fluctuations, hydrocarbons, methane, etc.

Secondary containment monitoring systems detect leaks in and around storage tanks, both large and small. Large, outdoor tanks have dikes around them to protect leaking liquid from escaping. Small tanks for hazardous liquids are often double-walled, with a space between the primary and secondary wall. This system can detect leaks from the primary containment into the secondary containment and, in the case of outdoor tanks with dikes, must be able to differentiate between water and the liquid to be detected. In some cases, the sensors can be able to withstand very harsh conditions, such as the presence of strong acids, corrosives, or solvents. This is primarily an alarming system, alerting personnel of a leak in the primary containment tank. It could be included with a tank overfill protection system.

Worker safety monitoring systems monitor the working environment for the workers' exposure to the hazards of hazardous chemicals, dust, noise, and energy. Personally worn sensors and wireless transmitters monitor for peak values of hazards and wirelessly notify a processor or central computing system if values exceed safe limits. Mounted sensors monitor for not only peak values but for time-weighted averages of hazards. These sensors communicate either by wire or wirelessly with a processor, such as local data processor 44, or another central computing device. If dangerous conditions develop, the processor takes necessary action to protect the workers by mitigating or eliminating the hazard while notifying responsible personnel and recording the data. Thus, the employees and management will be protected.

Hazardous environment monitoring systems monitor the areas where hazardous chemicals are processed, stored, transported, and disposed of. The systems are chemically specific, but are similar to secondary containment, landfill monitoring, tank overfill, and contaminated area monitoring systems. In addition, worker safety is of primary concern, and a worker safety monitoring system can be included.

In some applications of remote water quality monitoring, the number and diversity of the sources of water disallow the use of a single set of baseline values. For example, each water source may be unique in its chemical, physical, biological, and radiological properties, and the blending of water from these sources may not produce a baseline water quality that is consistent from day to day. For example, a municipality might draw water from both a reservoir and a well, where the well water has a higher pH than the water from the reservoir (or vice versa). On days when proportionally more water is being taken from the well than the reservoir, the baseline pH of the water blended from these sources would ordinarily be higher. Conversely, on days when proportionally more water comes from the reservoir, the pH would ordinarily be lower. To accommodate these expected variations, the quality and relative amounts of water from each of the sources can be monitored and the expected baseline values at the downstream monitoring stations periodically reset based on calculations of the expected water quality at these downstream sensing stations. Hydraulic modeling of the pumping, treatment, and distribution system and measured parameters of the water can be used to predict the appropriate baseline values. Alternatively or in addition, self-learning software, such as a neural network, can be trained to predict expected values based on historical water quality data and the relative amounts from the sources.

In use, sensors and local data processors would monitor the source waters and submit this information, to a central processor. The central processor collects the information from the various sources and predict what the water quality at various locations throughout the distribution system should be. For example, an iterative process can be employed where monitoring stations at upstream locations in the distribution system measure the actual water quality and transmit these measurements to a central processor. The central process can use this information and modeled flow rates through the system to calculates new baseline values for downstream monitoring stations. These new baseline values are then transmitted to the appropriate downstream monitoring stations and used for analysis, and the process can be repeated for even further downstream monitoring stations. Alternatively or in addition, the central processor can perform statistical analysis and comparisons to an accumulated library of data to detect variations and suggest possible causes of the variation at one or more of the monitoring stations.

While the inventions have been illustrated and described in detail in the drawings and foregoing description, the same is to be considered as illustrative and not restrictive in character, it being understood that only the preferred embodiments have been shown and described and that all equivalents, changes, and modifications that come within the spirit of the inventions described herein and by the following claims are desired to be protected.

What is claimed is:

1. A method, comprising:
monitoring water associated with at least one of a water source, water purification facility, water distribution facility, or water treatment facility;
operating a number of monitoring units remotely positioned with respect to one another to at least partially perform the monitoring, the units each including several different types of sensors to detect correspondingly different characteristics of the water, a processing subsystem and a two-way communication subsystem;
for each of the units, processing signals corresponding to the different characteristics with the processing subsystem;
for one of the units, detecting an abnormal condition by executing diagnostic logic; and
communicating the abnormal condition to a host with the two-way communication subsystem for the one of the units.

2. The method of claim 1, further comprising determining water quality based on the processed signals from at least two sensors.

3. The method of claim 1, wherein the diagnostic logic includes a decision criteria that depends on at least two different characteristics of the water.

4. The method of claim 3, wherein the detecting an abnormal condition includes cross-correlating values corresponding to different characteristics of the water.

5. The method of claim 1, wherein each of the monitoring units has a unique internet protocol address.

6. The method of claim 1, wherein, in response to the communicating, the host displays a visual indicator of the abnormal condition to an operator.

7. The method of claim 6, wherein the visual indicator is color coded to correspond to at least two different levels of severity of the abnormal condition.

8. The method of claim 1, wherein the host displays a map including icons representing the relative locations of the monitoring units.

9. The method of claim 8, further comprising selectively interrogating one of the units by selecting one of the icons via a pointer controlled by the operator.

10. The method of claim 9, further comprising, in response to the selective interrogation, displaying representations of values corresponding to the different characteristics of the water.

11. The method of claim 1, wherein the different types of sensors include at least a chlorine meter, a pH meter, an oxidation reduction potential meter, and a radiation meter.

12. The method of claim 11, wherein the radiation meter includes a first radiation detector exposed to the water and a second radiation detector open to atmospheric conditions.

13. The method of claim 12, wherein the processing subsystem uses data collected at the radiation reference device in determining a radiation level of the water.

14. The method of claim 1, wherein at least one of the host and the monitoring units mathematically processes historical data from at least one of the units to determine parameters for defining abnormal conditions for the at least one unit.

15. The method of claim 14, wherein, when parameters are determined from the historical data that differ from existing parameters, the parameters determined from the historical data are implemented in place of the existing parameters without user intervention.

16. A method, comprising:
monitoring water associated with at least one of a water source, water purification facility, water distribution facility, or water treatment facility;
operating a number of monitoring units remotely positioned with respect to one another to at least partially perform the monitoring, the units each including several sensors, a processing subsystem, and a communication subsystem;
with at least one of the units:
sensing pH, oxidation reduction potential, chlorine content, and radiation content of the water with the sensors and providing corresponding sensor signals;
determining an abnormal condition of the water as a function of the sensor signals with the processing subsystem; and
communicating the abnormal condition to another device with the communication subsystem.

17. The method of claim 16, wherein the other device is a host computer and the communicating is via an open communications network.

18. The method of claim 17, wherein the open communications network is the Internet.

19. A system for monitoring a water network comprising:
a number of monitoring units positioned at different locations in the network, the monitoring units each including sensors to detect chlorine content, a pH level, oxidation reduction potential, and radiation content of water in the water network, a processing subsystem and a two-way communication subsystem; and
a host computer having a processor and memory;
wherein each of the units is operable to:
process signals from the sensors with the processing subsystem;
detect an abnormal condition by executing diagnostic logic, wherein the diagnostic logic compares data relationships between the processed signals corresponding to at least two different characteristics; and
communicate the abnormal condition to the host computer with the two-way communication subsystem.

20. A device for detecting radiation in a supply of water comprising:
a first radiation detector inside a conduit for contact with the water;
a second radiation detector outside the conduit for establishing a baseline radiation level for reference; and
a processor for processing signals from the first and second radiation detectors to determine the level of radiation in the water.

21. The device of claim 20, wherein the processor is operable to compare the level of radiation in the water to the baseline radiation level.

22. The device of claim 20, wherein the first radiation detector is positioned within an elongated housing that extends from a wall of the conduit towards a centerline of the conduit.

23. The device of claim 22, wherein the housing is at least partially composed of a plastic material.

24. The device of claim 20, wherein the first radiation detector is at least partially coated with a rubber material.

25. The device claim 20, further comprising a test circuit and a reference circuit, wherein the test circuit receives data from the first radiation detector and transmits data to the processor, wherein the reference circuit receives data from the second radiation detector and transmits data to the processor.

26. The device of claim 20, wherein the second radiation detector is open to ambient conditions.

27. A method, comprising:
monitoring water associated with at least one of a water source, water purification facility, water distribution facility, or water treatment facility;
operating a number of monitoring units remotely positioned with respect to one another to at least partially perform the monitoring, the units each including one or more sensing devices to detect correspondingly different characteristics of the water and a local data processor;
the local data processor receiving data representing the characteristics from the sensing devices;
the local data processor analyzing the data; and
the local data processor communicating the data via a two-way communication system to a central computing system.

28. The method of claim 27, wherein, for each characteristic, the analyzing includes determining a current value of the characteristic and determining a current status of the characteristic relative to a normal value range associated with the characteristic.

29. The method of claim 27, wherein the units each include sensors operable to monitor pH, oxidation reduction potential, chlorine content, and radiation content.

30. The method of claim 27, wherein a first collective sensing device is operable to measure pH, chlorine content, and oxidation reduction potential of the water, and a second sensing device is operable to measure radiation content of the water.

31. The method of claim 27, wherein the controller device detects an abnormal condition based on diagnostic logic.

32. The method of claim 31, wherein the diagnostic logic includes comparison of the received data to a set of reference data and comparison of data associated with at least two characteristics.

33. The method of claim 31, further comprising initiating a response based on the abnormal condition.

34. The method of claim 33, wherein the response includes an alarm.

35. The method of claim 33, wherein the response includes an action taken with respect to the water to address the abnormal condition.

36. The method of claim 33, wherein the response includes notifying personnel of the abnormal condition.

37. The method of claim 27, further comprising:
the central computing system displaying a map including icons representing each of the monitoring units at respective locations of each of the monitoring units;
selecting an icon representing one of the monitoring units; and
the central computing system displaying characteristics of the water associated with the one of the monitoring units.

38. The method of claim 37, wherein the central computing system includes a three level color-coded alert system associated with the displayed map and the displayed characteristics.

39. A device for detecting radiation in water flowing through a conduit, comprising:
a first radiation detector positioned inside the conduit and contained in a housing that extends inwardly from a wall defining the conduit;
a second radiation detector outside the conduit for determining ambient radiation levels; and
a processor for processing signals from the first and second radiation detectors to determine the level of radiation in the water.

40. The device of claim 39 wherein the housing extends between opposed walls defining the conduit.

41. The device of claim 40 wherein the conduit defines a centerline and the housing passes through the centerline of the conduit.

42. The device of claim 39 wherein the conduit is a portion of a water distribution facility.

43. The device of claim 42 wherein the processor is coupled to a two-way communication system for communicating the determined level of radiation in the water to a central computing system.
